(19) United States
(12) Patent Application Publication
(10) Pub. No.: US 2014/0260135 A1
(43) Pub. Date: Sep. 18, 2014

(54) AIR-PRECLEANER

(71) Applicants: Robert Dingess, Sagamore Hills, OH (US); Paul D. Ellsworth, Richfield, OH (US); James N. Hudson, Fort Worth, TX (US)

(72) Inventors: Robert Dingess, Sagamore Hills, OH (US); Paul D. Ellsworth, Richfield, OH (US); James N. Hudson, Fort Worth, TX (US)

(73) Assignee: Maradyne Corporation, Cleveland, OH (US)

(21) Appl. No.: 13/801,042

(22) Filed: Mar. 13, 2013

(51) Int. Cl. B01D 45/14

(52) U.S. Cl. CPC B01D 45/14
USPC 55/447

(57) ABSTRACT

An air pre-cleaner for centrifugally ejecting heavier than air particulates from an air stream for use in an apparatus having an air intake includes an impeller assembly mounted for rotation with a wave washer. A two-part housing including first and second parts that are manually releasably securable together permits removal of housing part for cleaning of the pre-cleaner without the use of tools.

### BACKGROUND

This disclosure pertains to air pre-cleaners. More particularly, the disclosure relates to an air pre-cleaner employing an inlet vane assembly and a rotating impeller assembly.

Air pre-cleaners are used for removing particulates from the air prior to introducing the air through an air cleaner or filter, which is connected to a carburetor or air intake structure, of an internal combustion engine. Pre-cleaners are generally located on the open inlet side of the air intake pipes or stacks of an internal combustion engine. The function of the pre-cleaner is to remove as many contaminates from the air as possible before the air flows into an air filter medium upstream from the internal combustion engine.

Undesirable contaminates in the atmosphere include particulate matter such as dirt, dust, sand, snow and the like. While most engines include air filters which are meant to remove such contaminates from the air that feeds the engine, engine pre-cleaners are also beneficial in order to extend the life of the air filter and extend the engine's life while at the same time improving fuel economy.

Air pre-cleaners operate on the principle of centrifugal separation. Outside air, with its entrained contaminates, enters the pre-cleaner from the vacuum created by the engine. The air and contaminates traverse a set of fixed, static vanes which cause the air to circulate at a great speed. Centrifugal force throws the contaminates and moisture towards the outer wall of the pre-cleaner. The contaminates follow the wall until they reach an opening where they are discharged back into the atmosphere or collected. Clean, dry air is then allowed to enter the filter and subsequently, the internal combustion engine.

As pre-cleaners work on centrifugal separation, greater air flow velocity will result in better separation between the air and the contaminates. The best contaminate separation happens when the engine is running at a high speed (in r.p.m.) thus causing a high velocity for the air which is flowing into the pre-cleaner. As the velocity of air flow decreases, the centrifugal force on the contaminates also decreases reducing the separation efficiency of the pre-cleaner.

Several different designs of air pre-cleaners are commercially available in the marketplace. In one design, an air pre-cleaner uses a rotatable impeller or spinner to separate particles from air, discharge the dirty air and particle mixture circumferentially from a housing and direct the clean air to the air intake structure of an engine. The clean air moves centrally through a stack to the engine in response to a vacuum pressure on the air moving towards the engine. This air pre-cleaner has an air inlet vane assembly located in the bottom of the housing. The air flows upwardly in a circular path into a centrifugal separation chamber and then turns downwardly into the centrally located clean air exit opening. This impeller is used to pump air and particulate matter out through side discharge openings. This type of air pre-cleaner, however, does not urge the air flowing over the vanes of the pre-cleaner toward the outer walls of the separation chamber in order to enhance particle separation from the air.

Known air pre-cleaners have also included a design in which air flows into the top of the air pre-cleaner and flows axially downwardly through the pre-cleaner and into the intake stack of the engine. Although such pre-cleaners may perform adequately with respect to particulate material, this is accomplished sometimes at the expense of reduced air flow. In other words, the pre-cleaner itself may become an air restriction. The known pre-cleaners of this type do not use static vanes which cause the air to circulate at as great a velocity as such vanes could. Also, some pre-cleaners are only useable when positioned in one orientation, i.e., positioned on a vertical axis or positioned on a horizontal axis.

### BRIEF DESCRIPTION

An air pre-cleaner for centrifugally ejecting heavier than air particulates from an air stream for use in an apparatus having an air intake is provided.

More particularly, in one aspect of the disclosure a centrifugal particle separator comprises a vane assembly including a centrally positioned hub, a collar encircling the hub and a plurality of vanes circumferentially disposed about the hub, each vane having at least one of an inner end connected to the hub and an outer end connected to the collar and an impeller assembly mounted to said vane assembly via a fastener extending through a central bore defined in the impeller assembly, said impeller assembly being supported for rotation by at least one bearing received in said central bore, wherein a wave washer is disposed in said central bore between said bearing and a corresponding surface of said bore.

In accordance with another aspect of the disclosure, a centrifugal particle separator comprises a first housing member comprising a vane assembly including a centrally positioned hub, a collar encircling the hub and a plurality of vanes circumferentially disposed about the hub, each first vane having at least one of an inner end connected to the hub and an outer end connected to the collar, a second housing member manually releasably secured to said first housing member, and a resilient locking member carried by one of the first and second housing members and selectively engaging the other of the first and second housing members to selectively lock the first and second housing members to each other.

Still other benefits and advantages of the disclosure will become apparent to those skilled in the art upon a reading and understanding of the following detailed specification.

### BRIEF DESCRIPTION OF THE DRAWINGS

The disclosure may take physical form in certain parts and arrangements of parts preferred embodiments of which will be described in detail in this specification and illustrated in the accompanying drawings which form a part hereof and wherein:

FIG. 1 is an exploded front perspective view of a prior art air precleaner assembly including a centrifugal particle separator;

FIG. 2 is a greatly enlarged perspective view of a central bore of a prior art impeller;

FIG. 3 is a perspective exploded view of an exemplary air cleaner in accordance with a first embodiment of the present disclosure;

FIG. 4 is an enlarged perspective exploded view of an impeller assembly of the air cleaner of FIG. 3;

FIG. 5 is a greatly enlarged perspective view of a wave washer of the impeller assembly of FIG. 4;

FIG. 6 is an enlarged perspective view of an impeller of the impeller assembly of FIG. 4;

FIG. 7 is a fragmentary side elevational view of a two-part housing of an air precleaner assembly in accordance with a second embodiment of the present disclosure;

FIG. 8 is an enlarged fragmentary top perspective view of the two-part housing of FIG. 7; and

FIG. 9 is an enlarged fragmentary bottom perspective view of an interlocking feature of the two-part housing of FIG. 7.

### DETAILED DESCRIPTION

Referring now to the drawings wherein the showings are for purposes of illustrating preferred embodiments of the disclosure only and not for purposes of limiting same, FIG. 1 illustrates one example of an existing air pre-cleaner. The air precleaner assembly is generally identified by reference character A and includes a centrifugal particle separator B. While the centrifugal particle separator B is shown as part of an air precleaner assembly, it should be appreciated that the structures disclosed herein can be used in various applications which operate on the principle of centrifugal separation to remove contaminants from air. The air precleaner assembly A includes the centrifugal particle separator B comprising a first vane assembly 10 and a second vane assembly 50; a masking assembly 100; and a rotating impeller assembly 120. This embodiment of a prior art air pre-cleaner shows a “stacked vane” configuration with first and second vane assemblies 10 and 50.

The first vane assembly 10 is mounted atop the second vane assembly 50 because the air precleaner assembly A is orientated along a vertical axis. Therefore, the first vane assembly 10 will be termed hereafter the upper vane assembly and the second vane assembly 50 will be termed hereafter the lower vane assembly. It should be recognized, however, that if the air precleaner assembly A were to extend along a horizontal axis, the terms “upper” and “lower” would lose their respective meaning.

The upper vane assembly 10 includes a centrally positioned hub 12 and a plurality of vanes 26 circumferentially disposed about the hub 12. The hub blocks direct access of an airflow into the air precleaner A. The hub includes a top wall 14 and a peripheral skirt 16 depending therefrom. A stem 18 extends axially from the top wall 14 parallel to the skirt 16. The stem is approximately cruciform in a plan view. The skirt 16 and the stem 18 define between them a pie-shaped chamber 20. An opening 22 extends through the stem 18.

Each upper vane of the plurality of vanes 26 has a radially inner end 28 secured to the skirt 16 of the hub 12 and a radially outer end 30 secured to a collar 32 encircling the hub. Each upper vane can be angled downwardly and laterally about the hub and can have a concave surface along which inlet air flows. If desired, the degree of concavity of each vane can change along the length of the vane. The lower edge of the collar 32 includes an axially extending flange 40 for releasably securing the upper vane assembly 10 to the lower vane assembly 50.

The lower vane assembly 50 includes a centrally positioned hub 52 including a top wall 54 and a peripheral skirt 56 depending therefrom. A stem 58 extends axially from the top wall 54 and parallel to the skirt 56. The stem 58 is approximately cruciform in a plan view and is on the same longitudinal axis as the stem 18 of the upper vane assembly 10. A plurality of vanes 76 is circumferentially disposed about the hub 52. In this embodiment, each lower vane has a radially inner end secured to the skirt 56 of the hub 52 and a radially outer end secured to a collar 82 encircling the hub. Each lower vane can be angled downwardly and laterally about the hub and can have a concave surface along which inlet air flows. If desired, the degree of concavity of each vane can change along the length of the vane. A leading edge of each lower vane can extend above an upper edge of the collar 82.

Extending radially outwardly of the collar 82, at a bottom edge thereof, is a horizontal ledge 90. Although not shown in FIG. 1, an upper edge 88 of the collar 82 includes a recess dimensioned to receive the axially extending flange 40 for releasably securing the upper vane assembly 10 to the lower vane assembly 50.

The masking assembly 100 includes a masking hood 102 and a seal plate 104 selectively secured to a bottom end on the masking hood. Preferably, the masking hood has a general conical conformation for directing the inlet air to the rotating impeller assembly 120. However, it can be appreciated by one skilled in the art that the contour of the masking hood depends on the requirements needed for the end use of the air precleaner A. The masking hood includes a sidewall 106 and an axial flange extending from a top end which abuts against a bottom end of the peripheral skirt 56. Extending radially inward from the masking hood 102 is at least one gusset 110. The gusset has one end secured to an interior surface of the sidewall 106 and a second end secured to a depending boss 112. The boss has an aperture adapted to receive a fastener 114. The fastener secures the masking assembly 100 to the centrifugal particle separator B (as will be described in greater detail below). The seal plate 104 includes an opening 116 which receives a bolt 140. The bolt secures the seal plate within the bottom end of the masking hood 102.

Positioned adjacent the masking assembly 100 is the rotating impeller assembly 120. The rotating impeller assembly comprises a hub 122 having a bore 124 extending axially therethrough. Preferably, four arms 126 radiate away from the hub. Of course, more or less than four arms could be employed for the rotating impeller assembly. This would depend to some extent on the size of the air pre-cleaner. Secured to the hub 122 is a plurality of first blades 128, each of which is aligned with a respective one of the arms 126. The first blades are located at the proximal ends of the several arms. Each first blade 128 includes a first section 130 which is positioned above its respective arm and a second section 132 which is positioned below its respective arm.

Located at the distal end of each of the arms 126 is a respective second blade 134. Each second blade can be of compound shape and can include a first section 136 which is generally aligned with its respective arm 126 and a second section 138 which is oriented at an angle to the first section 136. The second blades of the impeller are of a shape that will not unload with increasing static pressure. The relationship of the sizeable first blades 128 and the compound second blades 134 combine to provide a blade assembly which will not unload at increasing static pressures. These blades combine to convert the rotational velocity of the impeller to static pressure at ejection ports better than straight, forward or backward curved blades. The unique shape of the second blades 134 combined with the fact that these blades are rotating in the perimeter of the air leaving the inlet vanes 26, 76 of the centrifugal particle separator B provides for particle extraction by both low pressure and centrifugal force as well as by mechanical separation.

A pair of bearings 144 and 146 can be positioned in the hub bore 124. The bearings 144 and 146 enable the rotating impeller assembly to smoothly rotate in relation to the centrifugal particle separator B. A washer 148 can be positioned between a head of the bolt 140 and the lower bearing 144. Also provided is a tubular bearing spacer 150 and a step washer (not shown) adjacent the upper bearing 146. The spacer is inserted in the bore 124 between the two bearings to prevent side loading of the bearings. The step washer can be oriented with the smaller diameter end of the washer resting on the adjacent bearing 146 and the larger diameter end resting on the bottom seal plate 104. Alternatively, two washers of different diameters can be stacked.

Also provided is a fastening means for securing the rotating impeller assembly 120 to the centrifugal particle separator B. The fastening means can comprise the bolt 140 and a lock nut 142. The lock nut can be generally hexagonally shaped and is positioned in a hexagonally shaped socket section in the lower vane assembly. The bolt extends upwardly through the hub 122 from the bottom end of the rotating impeller assembly 120, through the opening 116 of the seal plate 104, through the opening 62 of the stem 58 of the lower vane assembly 50 and into the socket section 64 thereof. As the bolt 140 is being secured to the lock nut 142, an end portion of the bolt extends through the top wall 54 of the hub 52 of the lower vane assembly and into the opening 22 of the stem 18 of the upper vane assembly 10. The mounting of the bolt in the lock nut further secures the seal plate 104 to the bottom end on the masking hood 102 and the larger diameter end of the step washer (not shown) onto the seal plate.

With additional reference to FIG. 2, the impeller assembly 120 has been molded (or otherwise provided) with a bore 124 that includes crush flats 154 located adjacent circumferentially extending spaced ribs 155 to ensure a close fit between the bearing 144 and the bore 124 upon assembly. Only one crush flat 154 is illustrated in FIG. 2, but it will be appreciated that typically a plurality of crush flats are distributed circumferentially about the inside surface of the hub structure 122 within the bore 124. In one embodiment there are four equally spaced crush flats for each of the two bearing pockets defined in the bore 124. Without the crush flats, the bearing can be easily too tight in the pocket or too loose taking into account the manufacturing tolerances. The crush flats allow for a greater tolerance because they will “crush” if they are too tight. Moreover, the bearings sometimes need to be seated to keep the flats from squeezing too much. If the flats squeeze too much, the bearing will have extra drag. In an extremely tight fit, the bearings will make noise as the impeller rotates. The crush flats 154 are designed to deform during installation of a bearing for a close fit of the bearing in the bore, a so-called press-fit. While such crush flats 154 can provide acceptable performance, they increase manufacturing costs and complexity and can also be disadvantageous in certain circumstances, as discussed above.

Turning now to FIGS. 3-6, an air pre-cleaner in accordance with a first embodiment of the present disclosure is there illustrated. Like components are identified by like numerals with a primed suffix (′) and new components are identified by new numerals. The air precleaner is identified generally by reference character A′. As will be described below, air pre-cleaner A′ includes a spring washer instead of crush flats for ensuring a close fit between a bearing and the bore of the rotating impeller. It will be appreciated that the air pre-cleaner A′ contains generally the same components as the air pre-cleaner A of FIG. 1. Moreover, it includes a rain hat 170, a vane assembly (not visible) located in a base 180, a masking assembly 100′ and a rotating impeller assembly 120′. A bolt 140′ secures the components together in a similar manner to bolt 140. A pair of bearings 144′ and 146′ can be positioned in a hub bore 124′. The bearings 144′ and 146′ enable the rotating impeller assembly to smoothly rotate in relation to the centrifugal particle separator B′. A washer 148′ can be positioned between a head of the bolt and the lower bearing 144′. Also provided is a tubular bearing spacer 150′. A base 158 includes an outlet opening 159 through which pre-cleaned air exits the pre-cleaner. In this embodiment, spring clips 184 are used to selectively secure the rain hat 170 to the base 158.

Unlike the air pre-cleaner A of FIG. 1, air pre-cleaner A′ further includes a wave washer 160 (FIGS. 4 and 5) interposed between the lower bearing 144′ and the spacer 150′ and received in the hub bore 124′. Wave washers are known and include portions or sections of the washer which protrude out of a plane of a remainder of the washer. Such portions enable the washer to be resiliently compressed while at the same time preloading the adjacent bearing. When compressed upon assembly of the pre-cleaner A′, the wave washer 160 ensures a tight fit between the hub bore 124′ and the bearing 144′ by accommodating slight variations in axial and/or radial tolerances of both the bearing and/or the hub bore structure. Moreover, the step washer of the prior art design has also been eliminated reducing the assembly cost of the air pre-cleaner, as the step washer was a machined component and thus relatively expensive. Instead, inexpensive fiber washers (unnumbered in FIG. 3) can be employed.

As shown in FIG. 6, the wave washer 160 is received within the bore 124′ and bottoms out on a plurality of circumferentially arranged axially extending ribs 155′ within the bore 124′. When the bolt 140′ and corresponding nut (not shown) are tightened, the wave washer is compressed between the bearing 144′ and the ribs 155′ thereby securing the bearing 144′ within the bore 124′. As such, the need for crush flats has been eliminated thereby simplifying the manufacturing process. By eliminating the crush flats of prior art designs, the disclosed embodiment allows for more consistent assembly of the bearings and the rotating impeller which reduces variability and increases the consistency in the rotational operation of the impeller assembly. Moreover, the introduction of the spring washer eliminates the need for a tight bearing pocket in the bore 124′. Now, the pocket tolerance can be shifted to a light interference to moderate clearance instead of the known tight interference to heavy interference fit.

Turning now to FIGS. 7-9, it will be appreciated that aspects of the present disclosure are also directed to a pre-cleaner having an easily separated two-part housing including an upper housing (for example, the illustrated rainhat) and a base. Unlike the prior art, the upper housing and the base can be quickly and easily separated without tools for cleaning. The prior art employs fasteners (such as the spring clips illustrated in FIG. 3) and a tool (such as a screwdriver or other flat bladed implement) is needed to disassemble the known two part housing. It will be appreciated that the components of the air pre-cleaner including the vane assemblies can be supported within the two-part housing. FIGS. 7 and 8 illustrate a two part housing made of a suitable resilient material, such as a known thermoplastic. The two part housing includes a rainhat 202 that is selectively secured to a base 204 via cooperating elements that restrict axial movement when engaged. To this end, each of the rainhat 202 and base 204 have mating features that can be aligned through relative rotation between such parts. In a first orientation, the mating features prevent axial movement between the rainhat 202 and the base 204. In a second orientation, the mating features do not restrict such axial movement and allow the rainhat 202 to be separated from the base 204.

With reference to FIG. 8, the rainhat 202 includes a plurality of ribs 210 separated by slots 212 to allow airflow into the housing. The rainhat also includes a flange 214 on which is mounted a manually actuated locking member 220. The locking member provides a quick connect coupling between the rainhat or first housing member 202 and the base or second housing member 204.

One example of mating features in accordance with the disclosure is shown in FIG. 9 wherein the locking member 220 includes at least one L-shaped tab 222 which is adapted to be received in a corresponding slot 230 of the base 204. Once inserted axially into the slot 230, rotation of the rainhat 202 relative to the base rotates a distal end of the tab 222 past an edge of the corresponding slot 230 thereby axially interlocking the rainhat 202 with the base 204. A plurality of such tabs 222 can be employed, and such tabs can be molded in to eliminate the possibility that separate fasteners (such as the spring clips shown in FIG. 3) could be lost upon disassembly of the two part housing. To prevent the parts from rotating back to an orientation where the tab 222 can be withdrawn from the slot 230, there is a notch that will accept a tab that will only be released if a pair of cooperating molded in levers 224 and 226 of the locking member 220 are manually squeezed together. As should be appreciated, the locking member 220 is made from a suitable resilient material, such as a thermo-plastic. The two-part housing, therefore, is manually releasably securable.

In other words, the housing first part (the rainhat) can be separated from the housing second part (the base) by an operator by twisting the housing first part in relation to the housing second part without the need to use tools. Such separation is desirable when the housing components become clogged and need to be cleaned out by hand while in use in the field. With the integral locking/unlocking features disclosed herein, the possibility of losing the spring clips or other separate locking elements of the prior art design upon disassembly of the housing members is eliminated. Also, no tool is needed to disassemble the housing members.

The instant disclosure has been described with reference to preferred embodiments. Obviously, modifications and alterations will occur to others upon the reading and understanding of the preceding specification. It is intended that the invention be construed as including all such alterations and modifications insofar as they come within the scope of the appended claims or the equivalents thereof.

1. A centrifugal particle separator comprising:
a vane assembly including a centrally positioned hub, a collar encircling the hub and a plurality of vanes circumferentially disposed about the hub, each vane having at least one of an inner end connected to the hub and an outer end connected to the collar; and
an impeller assembly mounted to said vane assembly via a fastener extending through a central bore defined in the impeller assembly, said impeller assembly being supported for rotation by at least one bearing received in said central bore, wherein a wave washer is disposed in said central bore between said bearing and a corresponding surface of said bore.

2. A centrifugal particle separator comprising:
a first housing member comprising a vane assembly including a centrally positioned hub, a collar encircling the hub and a plurality of vanes circumferentially disposed about the hub, each first vane having at least one of an inner end connected to the hub and an outer end connected to the collar;
a second housing member manually releasably secured to said first housing member; and
a resilient locking member carried by one of the first and second housing members and selectively engaging the other of the first and second housing members to selectively lock the first and second housing members to each other.
